(19) United States
(12) Patent Application Publication
(10) Pub. No.: US 2008/0287512 A1
(43) Pub. Date: Nov. 20, 2008

(54) Plant Protection Composition Including an Active Compound Selected from Azoles and a Solvent, and Useful Solvent Composition

(76) Inventor: Valerio Bramati, Arese (IT)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/914,330

(22) PCT Filed: May 10, 2006
(86) PCT No.: PCT/FR2006/001039

§ 371 Date: Dec. 17, 2007

(30) Foreign Application Priority Data
May 13, 2005 (FR) 0504847

(51) Int. Cl. A01N 43/653; A01N 25/02; A01P 15/00

(52) U.S. Cl. 514/383; 514/772

(57) ABSTRACT

The present invention relates to a concentrated plant protection composition containing an active compound selected from azoles and preferable triazoles such as tebuconazole. The composition contains at least one solvent. The composition is stable and easy for farmers to use. The present invention further relates to a useful solvent composition particularly suitable for implementing the plant protection composition.

The present invention relates to a concentrated plant-protection formulation comprising an active compound selected from azoles, preferably triazoles, for example tebuconazole. The composition comprises at least one solvent. The composition is stable and easy for farmers to use. The present invention further relates to a useful solvent composition particularly suitable for implementing the plant-protection composition.

Agriculture uses many active materials such as fertilizers or pesticides, for example insecticides, herbicides or fungicides. These are referred to as active plant-protection products (or active material). The active plant-protection products are generally produced in pure or highly concentrated form. They should be used on farms in low concentrations. To this end, they are generally formulated with other ingredients in order to allow easy weight dilution by the farmer. These are referred to as plant-protection formulations. The dilution performed by the farmer is generally carried out by mixing the plant-protection formulation with water.

Thus, plant-protection formulations should allow easy weight dilution by the farmer, in order to obtain a product in which the plant-protection product is correctly dispersed, for example in the form of a solution, emulsion, suspension or suspoemulsion. The plant-protection formulations thus allow the transportation of a plant-protection product in relatively concentrated form, easy packaging and/or easy handling for the final user. Various types of plant-protection formulations may be used according to the various plant-protection products. Mention may, for example, be made of emulsifiable concentrates (ECs), concentrated emulsions (emulsions in water EWs), microemulsions (MEs), wettable powders (WPs) and water-dispersible granules (WDGS). The formulations that may be used depend on the physical form of the plant-protection product (for example solid or liquid) and on its physicochemical properties in the presence of other compounds such as water or solvents.

After weight dilution by the farmer, for example by mixing with water, the plant-protection product may be in various physical forms: solution, dispersion of solid particles, dispersion of droplets of the product, droplets of solvent in which the product is dissolved, etc. The plant-protection formulations generally comprise compounds that allow these physical forms to be obtained. They may, for example, be surfactants, solvents, mineral supports and/or dispersants. These compounds quite often have no active nature, but an intermediary nature for aiding formulation. It is thus quite often desired to limit the amount thereof in order to limit the costs and/or any environmental unfriendliness. The plant-protection formulations may in particular be in liquid form or in solid form.

For practical reasons (for example for reasons of easy handling and/or transport), it may sometimes preferably be desired to use plant-protection formulations in solid form, and sometimes to use formulations in liquid form.

In order to prepare plant-protection formulations of solid active plant-protection products, it is known practice to solubilize the product in a solvent. The plant-protection formulation thus comprises a solution of the product in the solvent. The formulation may be in solid form, for example in the form of a wettable powder (WP), where the solution impregnates an inorganic support, for example kaolin and/or silica. The formulation may alternatively be in liquid form, for example in the form of an emulsifiable concentrate (EC) having a single clear liquid phase comprising the solvent and the product in solution, which can form an emulsion when water is added, without stirring or with gentle stirring. It may also be in the form of an emulsion in water (EW), which is turbid, in which the phase dispersed in the water comprises the solvent and the product in solution in the solvent. It may also be in the form of a microemulsion (ME), which is clear, in which the phase dispersed in the water comprises the solvent and the product in solution in the solvent.

Azoles, in particular triazoles, more particularly tebuconazole, are generally solid plant-protection products that are often difficult to formulate. Tebuconazole is a particularly effective fungicide that is widely used for, in particular, soybean cultivation. For these products, it is difficult to produce concentrated formulations that the farmer can easily dilute, that are stable and that do not have any substantial drawbacks (proven or perceived) in terms of safety, toxicity and/or ecotoxicity.

It is known practice to use liquid formulations in which the azoles are solubilized in a solvent or placed in the presence of a solvent (sometimes also called crystallization inhibitor). However, it remains difficult to formulate azoles, in particular triazoles, at relatively high concentrations with sufficient stability. In particular, it is necessary to prevent the appearance of crystals, in particular at low temperature and/or during dilution and/or during storage at high temperature of the diluted composition. The crystals can have negative effects, in particular blocking the filters of the devices used to spread the diluted composition, blocking spraying devices, decreasing the overall activity of the formulation, creating needless problems for waste companies in terms of eliminating the crystals, and/or causing poor distribution of the active product over the agricultural field.

There exists a need for new azole formulations, in particular triazole formulations.

The object of the invention is to meet this need and to prevent at least one of the drawbacks mentioned above. To this effect, the invention proposes a concentrated plant-protection formulation comprising:
a) an active plant-protection product selected from azoles, preferably triazoles,
b) at least one solvent,
c) optionally, at least one emulsifier, preferably a surfactant, and
d) optionally, water,
   characterized in that the solvent comprises a dialkyl alkyl phosphonate.

The invention also relates to the use of the concentrated formulation (or a method) for preparing a composition of the active plant-protection product, diluted in water, by mixing at least one part by weight of concentrated formulation with at least 10 parts of water, preferably less than 1000 parts. The diluted composition can, of course, comprise other active plant-protection products, that may originate from other plant-protection formulations, thus combined in the composition.

The invention also relates to the use of the solvent in concentrated formulations or in the diluted compositions.

The invention also relates to a solvent composition that is particularly effective and particularly useful for implementing the plant-protection formulation, and that can also be used for other purposes. The solvent composition comprises a mixture of solvents. It comprises:
b1) from 20% to 60%, preferably from 25% to 40%, by weight of dialkyl alkyl phosphonate,
b2) from 20% to 60%, preferably from 25% to 40%, by weight of an organic carbonate, and
b3) from 20% to 60%, preferably from 25% to 40%, by weight of a sulfoxide.

### DEFINITIONS

In the present application, the term “concentrated plant-protection formulation” is intended to mean a formulation intended to be mixed with water (for example, diluted) by the user, as opposed to a diluted plant-protection composition.

In the present application, when concentration ranges or proportions as % are used in a composition or a formulation, the total with, optionally, other ingredients is 100%.

In the present application, when concentration ranges or proportions in g/l are used in a composition or a formulation, the total with, optionally, other ingredients is such that it complies with the density of the composition or of the formulation (for 1 l, the total is equal to the density *1000).

In the present application, the term “solid plant-protection product” is intended to mean a product which has a melting point above 25° C.

### Active Plant-Protection Product a)

The active plant-protection product is an azole, preferably a triazole. The triazole may in particular be a compound other than tebuconazole, or advantageously tebuconazole.

Tebuconazole is the usual name of a compound known to those skilled in the art, the formula of which is the following:

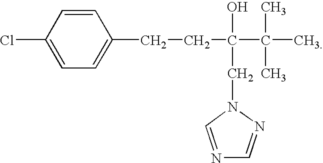

Tebuconazole is a solid plant-protection product.

By way of triazoles other than tebuconazole, mention may in particular be made of the following compounds: azaconazole, bitertanol; bromuconazole; cyproconazole; diclobutrazol; difenoconazole; diniconazole; diniconazole-M; epoxiconazole; etaconazole; fenbuconazole; fluotrimazole; fluquinconazole; flusilazole; flutriafol; furconazole; furconazole-cis; hexaconazole; imibenconazole; ipconazole; metconazole; myclobutanil; penconazole; prochloraz; propiconazole; prothioconazole; quinconazole; strobulurin and analogues, simeconazole; tetraconazole; triadimefon; triadimenol; triazbutil; triflumizole; triticonazole; uniconazole; uniconazole-P.

According to one embodiment, a solid azole, in particular a solid triazole, especially from those mentioned above, is used.

### Solvent b) and Mixture of Solvents and Solvent Composition

The plant-protection formulation comprises at least one solvent selected from dialkyl alkyl phosphonates. According to an advantageous embodiment, the solvent b) is a mixture of solvents. The expression “mixture of solvents in the concentrated plant-protection formulation” (or in the diluted composition) is intended to mean both a mixture prepared prior to the introduction into the formulation, and a combination, where the solvents are mixed while preparing the formulation, at the time they are brought together with the active plant-protection product.

The invention also relates to a particularly useful solvent composition comprising a mixture of solvents. In the solvent composition, the mixture of solvents is understood to be an effective mixture (as opposed to a combination), which is preferably clear.

The solvent comprises a dialkyl alkyl phosphonate. The dialkyl alkyl phosphonate preferably comprises at least 90% by weight of a compound of formula

R¹ₐP(═O)(—OR²)_{b}

in which:
a is an average number of approximately 1,
b is an average number of approximately 2,
a+b=3,
R¹ is a linear or branched alkyl group preferably containing from 1 to 12 carbon atoms, and
R² is a linear or branched alkyl group preferably containing from 1 to 12 carbon atoms.

The dialkyl alkyl phosphonate may comprise less than 10%, preferably less than 95% of impurities such as dialkyl phosphates or trialkyl phosphates.

According to an advantageous embodiment, dibutyl butyl phosphonate (DBBP) is used. Preferably, the dialkyl alkyl phosphonate comprises at least 90% by weight of dibutyl butyl phosphonate (DBBP). The product sold by Rhodia under the name Albrite DBBP may, for example, be used.

Advantageously, use is made of a mixture of solvents, or the solvent composition, comprising at least:
b1) the dialkyl alkyl phosphonate,
b2) an organic carbonate, and
b3) a sulfoxide.

Preferably, the mixture of solvents or the solvent composition comprises:
b1) from 20% to 60%, preferably from 25% to 40%, by weight of dialkyl alkyl phosphonate,
b2) from 20% to 60%, preferably from 25% to 40%, by weight of an organic carbonate, and
b3) from 20% to 60%, preferably from 25% to 40%, by weight of a sulfoxide.

The organic carbonate may in particular be selected from propylene carbonate, dimethyl carbonate, diethyl carbonate and ethylene carbonate. Propylene carbonate (“4-methyl-1,3-dioxan-2-one”) is most particularly preferred. Such a compound is in particular sold under the name Arconate for Lyondell.

The sulfoxide may in particular be selected from dimethyl sulfoxide (DMSO) and methyl sulfoxide.

A mixture of solvents, or a solvent composition, which is particularly advantageous comprises:
b1) from 25% to 40% by weight of dibutyl butyl phosphonate,
b2) from 25% to 40% by weight of propylene carbonate, and
b3) from 25% to 40% by weight of dimethyl sulfoxide (DMSO).

It is specified that, in general, the solvent composition comprises substantially no water (typically less than 5% by weight, preferably less than 1% by weight), and that it comprises substantially no active plant-protection product (typically less than 5% by weight, preferably less than 1% by weight). It is not impossible for it to comprise other solvents (other than water) and/or at least one surfactant.

As other solvents, which are minor solvents, and which it is possible to use in the mixture of solvents of the plant-protection formulation or in the solvent composition, mention may be made of lactate esters, carboxylic acid dimethylamides, fatty acid esters, hydrocarbon fractions, cyclic amides or lactones.

Without wishing to be bound to any theory, it is thought that the sulfoxide and/or the propylene carbonate helps to reduce the viscosity of the formulations comprising the dialkyl alkyl phosphonate. The sulfoxide helps to prevent the appearance of crystals after dilution with water, but promotes the appearance of crystals in the formulation at low temperatures. The propylene carbonate helps to prevent the appearance of crystals in the formulation, but promotes the appearance of crystals after dilution with water. The respective proportions of the various solvents can be refined by means of these indications, according to the desired viscosity, the plant-protection product to be solubilized and the required stability (in particular absence of crystallization)

### Emulsifier b)

The plant-protection formulation may comprise an emulsifier, typically and preferably a surfactant. Emulsifiers are agents intended to facilitate emulsification or dispersion after the formulation has been brought into contact with water, and/or to stabilize (over time and/or with respect to temperature) the emulsion or the dispersion, for example by preventing sedimentation.

Surfactants are known compounds which have a molar mass that is generally relatively low, for example less than 1000 g/mol. The surfactant may be an anionic surfactant in salified or acidic form, a nonionic surfactant, preferably polyalkoxylated, a cationic surfactant or an amphoteric surfactant (term also including zwitterionic surfactants). It may be a mixture or a combination of these surfactants. The surfactant may be a surfactant comprising an aromatic group (aromatic surfactant) or a surfactant not comprising an aromatic group (nonaromatic surfactant). It may be a mixture or a combination of these surfactants. In the case of mixtures of surfactants, it may be a mixture comprising at least one aromatic surfactant and at least one nonaromatic surfactant, or a mixture of several aromatic surfactants but no nonaromatic surfactant, or a mixture comprising several nonaromatic surfactants but no nonaromatic surfactant.

By way of examples of anionic surfactants, mention may be made, without wishing to be limited thereto, of:
alkylsulfonic acids or arylsulfonic acids, optionally substituted with one or more hydrocarbon-based groups, and the acid function of which is partially or totally salified, such as C₈-C₅₀, more particularly C₈-C₃₀, preferably C₁₀-C₂₂ alkylsulfonic acids, benzenesulfonic acids or naphthalenesulfonic acids substituted with one to three C₁-C₃₀, preferably C₄-C₁₆ alkyl and/or C₂-C₃₀, preferably C₄-C₁₆ alkenyl groups;
alkylsulfosuccinic acid monoesters or diesters, the linear or branched alkyl part of which is optionally substituted with one or more hydroxylated and/or linear or branched C₂-C₄ alkoxylated (preferably ethoxylated, propoxylated or ethopropoxylated) groups;
phosphate esters selected more particularly from those comprising at least one linear or branched, saturated, unsaturated or aromatic hydrocarbon-based group containing 8 to 40 and preferably 10 to 30 carbon atoms, optionally substituted with at least one alkoxylated (ethoxylated, propoxylated or ethopropoxylated) group. In addition, they comprise at least one monoesterified or diesterified phosphate ester group such that one or two free or partially or totally salified acid groups may be present. The preferred phosphate esters are of the type such as monoesters and diesters of phosphoric acid and of alkoxylated (ethoxylated and/or propoxylated) mono-, di- or tristyrylphenol, or of alkoxylated (ethoxylated and/or propoxylated) mono-, di- or trialkylphenol, optionally substituted with one to four alkyl groups; of phosphoric acid and of an alkoxylated (ethoxylated or ethopropoxylated) C₈-C₃₀ and preferably C₁₀-C₂₂ alcohol; of phosphoric acid and of a nonalkoxylated C₈-C₂₂ and preferably C₁₀-C₂₂ alcohol;
sulfate esters obtained from saturated or aromatic alcohols, optionally substituted with one or more alkoxylated (ethoxylated, propoxylated or ethopropoxylated) groups, and for which the sulfate functions are in free or partially or totally neutralized acid form. By way of example, mention may be made of the sulfate esters obtained more particularly from saturated or unsaturated C₈-C₂₀ alcohols, which may comprise 1 to 8 alkoxylated (ethoxylated, propoxylated or ethopropoxylated) units; the sulfate esters obtained from polyalkoxylated phenol, substituted with 1 to 3 saturated or unsaturated C₂-C₃₀ hydroxycarbon-based groups, and in which the number of alkoxylated units is between 2 and 40; the sulfate esters obtained from polyalkoxylated mono-, di- or tristyrylphenol in which the number of alkoxylated units ranges from 2 to 40.

The anionic surfactants may be in acid form (they are potentially anionic) or in a partially or totally salified form, with a counterion. The counterion may be an alkali metal, such as sodium or potassium, an alkaline earth metal, such as calcium, or an ammonium ion of formula N(R)₄⁺ in which R, which may be identical or different, represent a hydrogen atom or a C₁-C₄ alkyl radical optionally substituted with an oxygen atom.

By way of examples of nonionic surfactants, mention may be made, without wishing to be limited thereto, of:
polyalkoxylated (ethoxylated, propoxylated or ethopropoxylated) phenols substituted with at least one C₄-C₂₀ and preferably C₄-C₁₂ alkyl radical, or substituted with at least one alkylaryl radical, the alkyl part of which is C₁-C₆. More particularly, the total number of alkoxylated units is between 2 and 100. By way of example, mention may be made of polyalkoxylated mono-, di- or tri(phenylethyl)phenols, or polyalkoxylated nonylphenols. Among the ethoxylated and/or propoxylated, sulfated and/or phosphated di- or tristyrylphenols, mention may be made of ethoxylated bis(1-phenylethyl)phenol, containing 10 oxyethylenated units, ethoxylated bis(1-phenylethyl)phenol, containing 7 oxyethylenated units, ethoxylated sulfated bis(1-phenylethyl)phenol, containing 7 oxyethylenated units, ethoxylated tris(1-phenylethyl)phenol, containing 8 oxyethylenated units, ethoxylated tris(1-phenylethyl)phenol, containing 16 oxyethylenated units, ethoxylated sulfated tris 1-phenylethyl)phenol, containing 16 oxyethylenated units, ethoxylated tris(1-phenylethyl)phenol, containing 20 oxyethylenated units, and ethoxylated phosphated tris(1-phenylethyl)phenol, containing 16 oxyethylenated units;
optionally polyalkoxylated (ethoxylated, propoxylated or ethopropoxylated) C₄-C₂₂ and preferably C₆-C₂₂ fatty alcohols or fatty acids. When they are present, the number of alkoxylated units is between 1 and 60. The term “ethoxylated fatty acid” includes both the products obtained by ethoxylation of a fatty acid with ethylene oxide and those obtained by esterification of a fatty acid with a polyethylene glycol;
polyalkoxylated (ethoxylated, propoxylated or ethopropoxylated) triglycerides of plant or animal origin. Triglycerides derived from lard, tallow, groundnut oil, butter oil, cotton seed oil, linseed oil, olive oil, palm oil, grapeseed oil, fish oil, soybean oil, castor oil, rapeseed oil, copra oil or coconut oil, and comprising a total number of alkoxylated units of between 1 and 60, are thus suitable for use. The term “ethoxylated triglyceride” is directed both toward the products obtained by ethoxylation of a triglyceride with ethylene oxide and toward those obtained by transesterification of a triglyceride with a polyethylene glycol;
polyalkoxylated (ethoxylated, propoxylated or ethopropoxylated) sorbitan esters, more particularly cyclized sorbitol esters of C₁₀ to C₂₀ fatty acids, for instance lauric acid, stearic acid or oleic acid, and comprising a total number of alkoxylated units of between 2 and 50.

Preferably, the surfactant c) comprises at least 50% by weight of an ethoxylated and/or propoxylated di- or tristyrylphenol surfactant. These surfactants have a relatively high HLB. It may be advantageous to combine them with a surfactant having a lower HLB, for example a nonionic surfactant with a lower HLB. Such a combination may help to prevent sedimentation.

### Formulation

The formulation, which is preferably liquid, may typically comprise from 10 to 500 g/l of the active plant-protection product. This proportion may be from 200 to 300 g/l, or even less, for example from 10 to 100 g/l or from 100 to 200 g/l.

According to an advantageous embodiment, the formulation comprises:
a) from 10 to 500 g/l and preferably 200 to 300 g/l of the plant-protection product, by weight of active material,
b) from 150 to 800 g/l of solvent, and preferably from 600 to 700 g/l,
c) from 30 to 300 g/l of surfactant, and preferably from 100 to 250 g/l, by weight of active material (surfactant material, solids), and
d) from 0 to 100 g/l of water,
   the solvent b) being a mixture of solvents comprising at least:
b1) from 20% to 60%, preferably from 25% to 40%, by weight of dialkyl alkyl phosphonate, b2) from 20% to 60%, preferably from 25% to 40%, by weight of an organic carbonate, and
b3) from 20% to 60%, preferably from 25% to 40%, by weight of a sulfoxide.

The concentrated formulation does not comprise large amounts of water. The water content is typically less than 50% by weight, advantageously less than 25% by weight.

The formulation is preferably a liquid formulation, for example in the form of an emulsifiable concentrate (EC), an emulsion in water (EW) or a microemulsion (ME). In this case, it preferably comprises less than 500 g/l of water, more preferably less than 250 g/l.

The possibility of preparing solid formulations, for example formulations in which a liquid comprising the plant-protection product solubilized in the solvent or the mixture of solvents or the solvent composition is supported by a mineral and/or dispersed in a solid matrix, is not excluded.

The formulation may, of course, comprise ingredients other than the active plant-protection product, the solvent(s), the optional emulsifier(s) and the optional water. It may in particular comprise viscosity modifiers, antifoams, in particular silicone-based antifoams, anti-rebound agents, agents for preventing washing off, inert fillers, in particular inorganic fillers, frost-protection agents, etc.

### Method

Conventional methods for preparing plant-protection formulations or mixtures of solvents can be used. The process can be carried out by simple mixing of the constituents.

For the preparation of the plant-protection formulations comprising a mixture or a combination of solvents, the various solvents may in particular be introduced separately. A mixture of solvents prepared beforehand, typically the solvent composition, may also be introduced.

The solvent composition may be prepared by simple mixing of the solvents.

### Use of the Plant-Protection Formulation

The concentrated plant-protection formulation is intended to be spread over a cultivated field or a field to be cultivated, for example a field of soybean, most commonly after dilution in water, so as to obtain a diluted composition. The dilution is generally performed by the farmer, directly in a tank (“tank-mix”), for example in the tank of a device for spreading the composition. The possibility of the farmer adding other plant-protection products, for example fungicides, herbicides, pesticides, insecticides or fertilizers, is not excluded. Thus, the formulation may be used for preparing a composition of the active plant-protection product, diluted in water, by mixing at least one part by weight of concentrated formulation with at least 10 parts of water, preferably less than 1000 parts. The dilution rate and the amounts to be applied to the field generally depend on the plant-protection product and on the dose desired for treating the field; this can be determined by the farmer.

Other details or advantages of the invention will become apparent in view of the examples which follow and which are not limiting in nature.

### EXAMPLES

The following ingredients are used:
DMSO.
Propylene carbonate.
Solvent A: combination of
   36% by weight of DMSO,
   32% by weight of propylene carbonate,
   32% by weight of DBBP (Albrite DBBP, Rhodia).
Tebuconazole at 96.34% with respect to active material.
Geronol TE 777, Rhodia: surfactant comprising more than 50% by weight of ethopropoxylated tristyrylphenol.
Alkamuls OR 36, Rhodia: ethoxylated castor oil.
Antarox B 848, Rhodia: ethopropoxylated alcohol.

Plant-protection formulations are prepared by mixing the ingredients so as to obtain a tebuconazole concentration of 250 g/l.

The following tests are carried out:
pH: test CIPAC MT75.
Stability after dilution (“emulsification”): test CIPAC MT36, carried out at concentrations after dilution of 2% and/or 5%, at 30° C., before and after storage for 14 days at 54° C., with water hardness A (20 ppm), D (342 ppm), C (500 ppm) or 1000 ppm.
Test of appearance of the formulation at 0° C. or at 54° C.: test CIPAC MT39 (0° C.) and MT46 (54° C.).

| | Example 1C | Example 2C | Example 3C | Example 4 |
|---|---|---|---|---|
| Tebuconazole | 250 g/l | 250 g/l | 250 g/l | 250 g/l |
| (active | | | | |
| material) | | | | |
| DMSO | volume for | | 20/80 by | |
| | volume | | weight | |
| Propylene | | volume for | DMSO/ | |
| carbonate | | volume | propylene | |
| | | | carbonate | |
| Solvent A | | | | volume |
| | | | | for |
| | | | | volume |
| Geronol TE 777 | | | | |
| Appearance | crystals | some | no crystals | no |
| 0° C. | | crystals | | crystals |
| Emulsification | | | many | no |
| (5%, 30° C.) | | | crystals | crystals |

The letter C indicates that it is a comparative example.

### Example 5

The following formulation is prepared:

| | g/l |
|---|---|
| Tebuconazole | 250 (with respect to active material) |
| Solvent A | 633 |
| Water | 25 |
| Geronol TE/777 | 180 |

The density is 1.098.

The pH is 7.2.

| | A | D | C | 1000 ppm |
|---|---|---|---|---|
| Emulsification | OK | OK | OK | OK |
| 2%, 30° C., | | | | |
| after 2 h | | | | |
| Emulsification | OK | OK | OK | OK |
| 5%, 30° C., | | | | |
| after 2 h | | | | |
| After 14 days | OK | OK | OK | OK |
| at 54° C. | | | | |
| emulsification | | | | |
| 5%, 30° C., | | | | |
| after 2 h | | | | |

Appearance 0° C.: clear solution, OK
Appearance 54° C.: clear solution, OK

The formulations of examples 4 and 5 show excellent properties with regard to noncrystallization, and are particularly favored due to the fact that they have a low danger level and/or low toxicity.

### Example 6

The following formulation, which does not comprise an aromatic surfactant, is prepared:

| | g/l |
|---|---|
| Tebuconazole | 250 (with respect to active material) |
| Solvent A | 635 |
| Water | 25 |
| Alkamuls OR 36 | 108 |
| Antarox B 848 | 72 |

The formulation of example 6 shows excellent properties with regard to noncrystallization, and is particularly favored due to the fact that it has a low danger level and/or low toxicity.

1-14. (canceled)

15. A concentrated plant-protection composition comprising:
a) an active plant-protection product including azoles, and
b) at least one solvent,
wherein the solvent comprises a dialkyl alkyl phosphonate.

16. The composition of claim 15, wherein the azoles are triazoles.

17. The composition of claim 15, wherein the active plant-protection product is tebuconazole.

18. The composition of claim 15, further comprising:
c) at least one emulsifier, and/or
d) water.

19. The composition of claim 18, wherein the emulsifier is a surfactant.

20. The composition of claim 15, wherein the solvent b) is a mixture of solvents comprising:
b1) dialkyl alkyl phosphonate,
b2) an organic carbonate, and
b3) a sulfoxide.

21. The composition of claim 20, wherein the organic carbonate is propylene carbonate.

22. The composition of claim 20, wherein the sulfoxide is dimethyl sulfoxide (DMSO).

23. The composition of claim 19 comprising:
a) the plant-protection product in an amount ranging from 10 to 500 g/L by weight of active material,
b) solvent in an amount ranging from 150 to 800 g/L,
c) surfactant in an amount ranging from 30 to 300 g/L by weight of active material, and
d) water in an amount ranging from 0 to 100 g/L, the solvent b) being a mixture of solvents comprising:
b 1) dialkyl alkyl phosphonate in an amount ranging from 20% to 60% by weight,
b2) organic carbonate in an amount ranging from 20% to 60% by weight, and
b3) a sulfoxide in an amount ranging from 20% to 60% by weight.

24. The composition of claim 23, wherein:
a) the plant-protection product is present in an amount ranging from 200 to 300 g/L by weight of active material,
the solvent b) is present in an amount ranging from 600 to 700 g/L,
the surfactant c) is present in an amount ranging from 100 to 250 g/L by weight of active material, and/or
water d) is present in an amount ranging from 0 to 100 g/L;
and wherein:
the dialkyl alkyl phosphonate b1) is present in an amount ranging from 25% to 40% by weight,
the organic carbonate b2) is present in an amount ranging from 25% to 40% by weight, and/or
the sulfoxide b3) is present in an amount ranging from 25% to 40% by weight.

25. The composition of claim 15, wherein the dialkyl alkyl phosphonate comprises at least 90% by weight of dibutyl butyl phosphonate (DBBP).

26. The composition of claim 19, wherein the surfactant includes nonionic surfactants, anionic surfactants, amphoteric surfactants, or mixtures thereof.

27. The composition of claim 19, wherein the surfactant comprises at least 50% by weight of an ethoxylated and/or propoxylated di- or tristyrylphenol surfactant.

28. The composition of claim 15, wherein the composition is an emulsifiable concentrate, an emulsion in water or a microemulsion, comprising less than 500 g/L of water.

29. A method of preparing a diluted composition comprising mixing at least one part by weight of the composition of claim 15 with at least 10 parts by weight of water.

30. The method of claim 29, wherein the amount of water is less than 1000 parts by weight.

31. A solvent composition comprising a mixture of solvents, wherein the solvent composition comprises:
b1) dialkyl alkyl phosphonate in an amount ranging from 20% to 60% by weight,
b2) organic carbonate in an amount ranging from 20% to 60% by weight, and
b3) a sulfoxide in an amount ranging from 20% to 60% by weight.

32. The solvent composition of claim 31, wherein:
the dialkyl alkyl phosphonate b1) is present in an amount ranging from 25% to 40% by weight,
the organic carbonate b2) is present in an amount ranging from 25% to 40% by weight, and/or
the sulfoxide b3) is present in an amount ranging from 25% to 40% by weight.

33. The solvent composition of claim 31, wherein the composition comprises:
b1) dibutyl butyl phosphonate in an amount ranging from 25% to 40% by weight,
b2) propylene carbonate in an amount ranging from 25% to 40% by weight, and
b3) dimethyl sulfoxide (DMSO) in an amount ranging from 25% to 40% by weight.

34. The solvent composition of claim 31, wherein the composition comprises substantially no water and substantially no active plant-protection product.

35. The composition of claim 34, wherein the composition further comprises other solvents and/or at least one surfactant.
